(19) United States
(12) Patent Application Publication
(10) Pub. No.: US 2025/0187065 A1
(43) Pub. Date: Jun. 12, 2025

(54) Casting Apparatus and Manufacturing Methods Thereof

(71) Applicant: Brian Tooley Racing, Inc., Bardstown, KY (US)

(72) Inventors: Richard William Smith, Jr., Bardstown, KY (US); Robert A. Braun, Bardstown, KY (US); Brandon A. Lamoncha, Bardstown, KY (US)

(73) Assignee: Brian Tooley Racing, Inc., Bardstown, KY (US)

(21) Appl. No.: 18/981,303

(22) Filed: Dec. 13, 2024

Related U.S. Application Data
(60) Provisional application No. 63/606,940, filed on Dec. 6, 2023.

(51) Int. Cl. B22C 9/02; B22C 9/10; B33Y 10/00; B33Y 80/00

(52) U.S. Cl. CPC B22C 9/02; B22C 9/106; B33Y 80/00; B33Y 10/00

(57) ABSTRACT

A sand core for casting, a method for forming the sand core, and a casting method are provided. The sand core includes a sand core shell that features a designed variability in wall thickness thereof, and has one or more venting paths that open to an external space formed therein. The sand core further includes molding sand partially filled in the sand core shell. The molding sand comprises coated, non-catalyzed sand. The sand core is formed by 3-Dimensionally (3D) printing the sand core shell. During casting, the sand core is placed a sand core into a cavity in a mold and a molten metal is poured into the cavity. The molten metal solidifies around the sand core to form a solidified metal structure. The solidified metal structure is then removed from the mold and the sand core is separated from the solidified metal structure.

### CROSS-REFERENCE TO RELATED APPLICATIONS

This application claims priority to U.S. Provisional Application No. 63/606,940, filed Dec. 6, 2023, the entirety of which is incorporated herein by reference.

### FIELD

The present disclosure relates to castings. More particularly, the present disclosure relates to castings featuring internal passages that benefit from a reduction of resin content while preserving core integrity.

### BACKGROUND

Castings with intricate internal passages may be crafted using sand cores bonded with resin and catalyst, ensuring the sand core maintains its shape when exposed to molten metal. To withstand the metal's stress and filling pressure, a higher resin content is used in sand cores, especially for intricate passages alongside bulkier sand cross-sections. During solidification, the released heat from the metal causes the resin to break down and burn, resulting in gas evolution. Excessive gas can lead to the formation of pockets, commonly known as blows, causing casting defects, and rendering the casting unusable.

Further, removing broken-down sand from castings with intricate internal passages can be a challenging and time-consuming task during post-processing. This challenge is intensified by the necessity for small core print sizes required for optimal part performance in specific applications. Core prints may refer to features in the mold that support and align the sand cores, and size of the core prints may directly impact the openings or pathways available for sand removal. For example, smaller core prints may result in narrower or fewer access points, restricting the ability to break down and extract the sand effectively after the casting is complete.

Traditional sand cores in casting processes require draft for molding. The draft may compromise the precision of the shape and the cavity cross-sections. For example, when casting a part with tight tolerances or intricate internal features, the draft can distort the intricate internal features, making the final casting not as precise as desired. While shell core processes offer a randomly hollow internal cavity, issues arise when core prints close off solid, trapping uncured internal resin-bonded sand. Despite the external surface being heat-cured and in contact with molten metal, the trapped resin-coated sand can still contribute to gas generation, presenting challenges in achieving high-quality castings.

### SUMMARY OF THE DISCLOSURE

A sand core for casting, a method for forming the sand core, and a casting method in accordance with embodiments of the disclosure are described herein.

In many embodiments, a sand core for casting comprises a sand core shell that features a designed variability in wall thickness thereof, and has one or more venting paths that open to an external space formed therein. Molding sand is filled in the sand core shell. The molding sand comprises coated, non-catalyzed sand.

In a number of embodiments, the sand core shell is a 3-Dimensional (3D)-printed sand core shell.

In a variety of embodiments, the designed variability in the wall thickness is based on a 3D-mesh file associated with the sand core shell.

In more embodiments, the sand core shell includes one or more core prints on a first section of the sand core shell to position the sand core shell relative to a mold.

In additional embodiments, a first wall portion of the sand core shell proximate to the one or more core prints is thicker than a second wall portion of the sand core shell that is distant from the one or more core prints.

In several embodiments, the one or more venting paths are integral to the sand core shell.

In numerous embodiments, the one or more venting paths are defined by a 3D-mesh file associated with the sand core shell.

In various embodiments, the molding sand comprises uncured sand.

In further embodiments, the sand core shell comprises at least one first section free of uncured sand and at least one second section featuring at least one cavity filled with the uncured sand.

In still yet more embodiments, the at least one cavity exhibits freeform geometry.

In one or more embodiments, a material of the at least one first section is different from the uncured sand.

In yet more embodiments, the uncured sand is acid coated sand.

In still more embodiments, the uncured sand includes air gaps between individual sand grains, and the air gaps exhibit an insulation effect on the sand core shell.

In many further embodiments, the one or more venting paths that open to the external space function as gas migration channels from inside the sand core shell to the external space.

In many additional embodiments, the pre-filter assembly incorporates one or more interlocking features. The pre-filter assembly is secured to the perimeter frame in the detachable configuration by way of the one or more interlocking features.

In numerous additional embodiments, the sand core is a water jacket sand core.

In several additional embodiments, a method for forming a sand core comprises 3-Dimensionally (3D) printing a sand core shell that features a designed variability in wall thickness thereof. The sand core shell comprises one or more venting paths that open to an external space and one or more cavities filled with molding sand. The molding sand comprises coated, non-catalyzed sand.

In yet additional embodiments, the sand core shell is 3D-printed based on a 3D-mesh file.

In still additional embodiments, the 3D-mesh file is configured to indicate one or more parameters for featuring the designed variability in the wall thickness of the sand core shell.

In still yet additional embodiments, a casting method comprises placing a sand core into a cavity in a mold. The sand core comprises a sand core shell that features a designed variability in wall thickness thereof, and has one or more venting paths that open to an external space formed therein. Molding sand is filled in the sand core shell. The molding sand comprises coated, non-catalyzed sand. The method further comprises pouring a molten metal into the cavity. The molten metal solidifies around the sand core to form a solidified metal structure. The method further comprises removing the solidified metal structure from the mold, and separating the sand core from the solidified metal structure.

In yet several embodiments, the sand core is a water jacket sand core and the solidified metal structure is a cylinder head.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of an example sand core used in a casting process in accordance with various embodiments of the disclosure;

FIG. 2 is a conceptual illustration of a sand core shell of a sand core overlayed with a casting metal part in accordance with various embodiments of the disclosure;

FIGS. 3A-3G are conceptual illustrations of various views of a casting metal part overlayed on a sand core in accordance with various embodiments of the disclosure;

FIG. 4 is a conceptual illustration of an example hollowed out, 3D printed sand core in accordance with various embodiments of the disclosure;

FIG. 5 is a conceptual illustration of a cut section view of a cylinder head removed from a molding cavity in accordance with various embodiments of the disclosure;

FIG. 6 is a flowchart showing a process for forming a sand core in accordance with various embodiments of the disclosure; and

FIG. 7 is a flowchart showing a process for a casting method in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the problems described above, devices and methods are discussed herein that provide a sand core for casting. The sand core includes a sand core shell featuring designed variability in wall thickness thereof. The sand core further includes molding sand partially filled in the sand core shell. For example, the molding sand is filled in various organic-shaped cavities formed in the sand core shell. “Organic shape” may refer to freeform geometry that lacks sharp corners or strict symmetry, and is more natural or biomorphic. The molding sand includes coated, non-catalyzed sand. Further, the molding sand may be uncured. acid coated sand which does not get hardened during the casting process. Thus, the sand core of the present disclosure deviates from traditional cavity withdrawal constraints, for example, due to freeform geometry of the cavities. As described herein, such embodiments significantly reduce resin/binder content compared to traditional sand cores, leading to a desirable decrease in gas evolution during casting.

Further, the sand core shell has one or more venting paths that open to an external space formed therein. These venting paths may function as gas migration channels from inside the sand core shell to the external space. External space can be any space that is outside of the sand core. The outcome is a notable reduction or elimination of casting scrap, particularly due to gas blow defects. For example, as the gas that gets formed during casting migrates (or escapes) to outside of the sand core shell via the venting paths, intricate internal passages formed within the casting by the sand core effectively retain their desired shape.

Additionally, costs may be reduced by minimizing shakeout time. The reduced amount of hardened sand also leads to a significant decrease in processing times for internal sand removal during casting, enhancing overall efficiency in the manufacturing process. For example, the sand core of the present disclosure has strong outer crust (e.g., the sand core shell) that can withstand the heat of the molten metal during casting, with the uncured, coated, non-catalyzed sand filled in the organic-shaped cavities. For example, the uncured sand includes air gaps between individual sand grains, and the air gaps may exhibit an insulation effect on the sand core shell. In an example, the thinner the outer solid crust, the more effective the insulation effect. Once the casting is complete and the shakeout process is performed, the outer crust breaks which exposes the uncured, free-flowing molding sand. The molding sand thus escapes the cavities very early in the shakeout process.

In further embodiments, the sand core shell may be a 3-dimensional (3D) printed sand core shell. For example, 3D-printing may performed based on a 3D-mesh file. The 3D-mesh file may define one or more parameters for featuring the designed variability in the wall thickness of the sand core shell. Traditional sand cores typically have randomized wall thickness and are never identical due to the nature of the sand blow and core box rotational manipulation. However, the 3D-printed sand cores are uniform and consistent as they are formed based on a 3D-mesh file. Thus, the variability in the wall thickness of the sand core shell of the 3D-printed sand core is not random or inconsistent but designed as per requirements. In an example, the sand core shell may include one or more core prints on a first section of the sand core shell to position the sand core shell relative to a mold. A first wall portion of the sand core shell proximate to the one or more core prints may be thicker than a second wall portion of the sand core shell that is distant from the one or more core prints. The variability in wall thickness also reduces the content of resin binder cured sand used in the sand core. In numerous embodiments, the one or more venting paths may be integral to the sand core shell, and may be defined by the 3D-mesh file associated with the sand core shell. In other words, the one or more venting paths may be formed as part of the 3D-printing process, thus, eliminating the need of adding venting paths by a post processing drilling operation.

In many embodiments, the ratio of minimum wall thickness remains relative to the overall cross-section of the cored passage, underscoring the significance of preserving sand core geometry while reducing resin content. Furthermore, if a mold cavity exhibits a rise relative to the horizon, reducing resin content below that summit proves particularly advantageous. In many embodiments, this is attributed to the natural migration of hot gases towards the high point in the mold cavity. Thus, an amount of resin-bind cured sand decreases from a first section of the sand core shell to a second section of the sand core shell. For example, the amount of the resin-bind cured sand decreases from a lower section of the sand core shell to an upper section of the sand core shell, emphasizing the strategic benefit of minimizing resin at such elevated locations.

In more embodiments, a casting part may be casted using the sand core of the present disclosure. For example, the sand core may be placed into a cavity in a mold a molten metal may be poured into the cavity. The molten metal may solidify around the sand core to form a solidified metal structure. The sand core may define internal voids, intricate internal passages, etc. within the solidified metal structure, whereas the mold may define an outer shape of the solidified metal structure. The solidified metal structure may then be removed from the mold, and the sand core may be separated from the solidified metal structure, for example, by a shakeout process. In an example, the casting part may be a cylinder head.

In an example embodiment, the sand core may be a water jacket sand core. “Water jacket sand core” may be utilized in a casting process to create, within a casting part, internal voids, intricate internal passages, or cavities through which coolant (usually water or a water-antifreeze mixture) may be circulated. However, it should be appreciated that embodiments described herein may apply without limitation to any casting featuring one or more internal passages.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

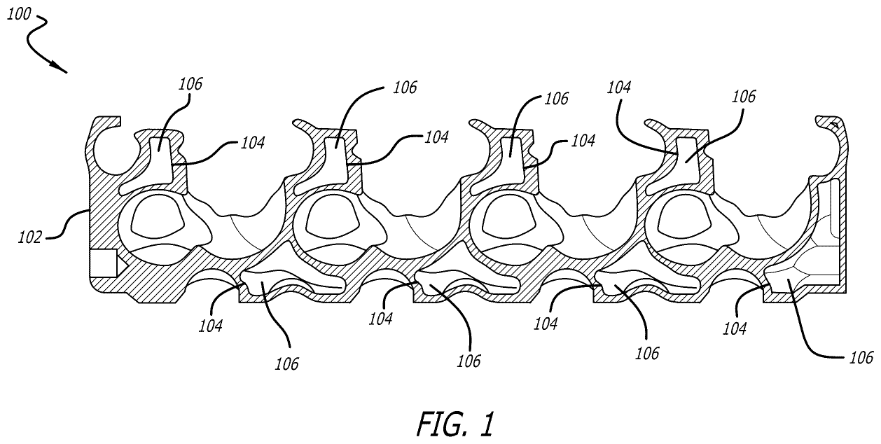

Referring to FIG. 1, a conceptual illustration of an example sand core 100 used in a casting process in accordance with various embodiments of the disclosure is shown. In many embodiments, the sand core 100 may correspond to a hollowed-out sand core. The sand core 100 may be utilized in the casting process to form internal cavities, intricate internal passages, or complex geometries within a cast metal part. In an example, the cast metal part may be a cylinder head, which requires formation of internal passages for a water jacket to enable engine cooling. The sand core 100 may be utilized as a water jacket sand core to form the intricate network of internal passages within the cylinder head.

In a number of embodiments, during the casting process, the sand core 100 may be positioned inside a mold cavity, and molten metal may be poured into the cavity. The molten metal may solidify around the sand core 100 to form to a solidified metal structure. Once the molten metal has solidified, the solidified metal structure along with the sand core 100 is removed from the mold cavity, and the sand core 100 is separated from the solidified metal structure, leaving behind the internal passages within the solidified metal structure.

In a variety of embodiments, the sand core 100 may include a sand core shell 102 featuring designed variability in wall thickness thereof. Designed variability in wall thickness may refer to a structural design where wall thickness of the sand core shell 102 is deliberately varied in specific, calculated ways across different regions. Here, the designed variability is not a result of manufacturing inconsistencies, but is incorporated to optimize the performance of the sand core shell 102 for its intended function. The variation in the wall thickness can be tailored to address various factors such as mechanical stress, weight distribution, heat transfer, or the like. For example, areas of the sand core shell 102 that are prone to higher stress during casting may be designed with thicker walls (for example, two times or three times thicker) for added strength, than areas that are prone to lower stress during casting.

In more embodiments, the sand core 100 may further include molding sand 106 partially filled in the sand core shell 102. To achieve this, the sand core shell 102 may include various organic-shaped cavities 104 that are filled with the molding sand 106. These cavities 104 may exhibit freeform geometry that lacks sharp corners or strict symmetry, and is more natural or biomorphic. Further, the organic shape contrasts with traditional geometric designs, providing various benefits such as enhanced flexibility, better load distribution, or improved heat dissipation. The cavities 104 may be enclosed chambers integrated into the walls of the sand core shell 102. In other words, the cavities 104 are not open spaces but voids that are surrounded by the walls of the sand core shell 102 and are filled with the molding sand 106. Further, the sand core 100 of the present disclosure deviates from traditional cavity withdrawal constraints, for example, due to freeform geometry of the cavities 104.

In one or more embodiments, the cavities 104 filled with the molding sand 106 may be formed in those sections of the sand core shell 102 that require, for example, two to three times, thicker walls due likelihood of experiencing higher mechanical stress during casting. The molding sand 106 entrapped within the cavities 104 provide compression support to persist cavity pressure or stress during molten metal filling. However, in sections where the stress is likely to be high but due to space constraints thickness of the wall cannot be increased, the wall of the sand core shell 102 can be left solid to ensure structural integrity. In other words, the sand core shell 102 may include at least one first section free of uncured sand, and at least one second section featuring the cavity 104 filled with the uncured molding sand 106. The first section that is free of uncured sand may correspond to solid wall section of the sand core shell 102 that is formed with cured sand. In FIG. 1, the solid wall section is depicted with a patterned design featuring slanting lines.

In yet more embodiments, the molding sand 106 may include coated, non-catalyzed sand. In further embodiments, the molding sand 106 can also include uncured, acid coated sand, which does not get hardened during the casting process when subject to metal heat. In an example, the acid coated molding sand 106 is virtually inert and non-reactive for gas evolution. In many further embodiments, a material of the at least one first section (e.g., the solid wall section) in the sand core shell 102 is different from the uncured molding sand 106.

Conventional solid sand cores, formed by binding sand particles with a resin binder for strength and stability, pose challenges in casting due to decomposition of the resin binder when exposed to molten metal heat. Decomposition of the resin binder may generate gases during the metal pouring process. These gases can become trapped, leading to defects such as porosity or gas pockets in the cast metal part. Further, conventional shell sand cores have resin-bonded uncured sand trapped within a solid crust throughout the core shell body. In contrast, the sand core 100 featuring the hollowed-out sand core geometry has uncured, acid coated, non-catalyzed molding sand 106 in select sections of the sand core shell 102, for example, within the cavities 104. Thus, an overall volume of the resin binder in the sand core 100 is reduced in comparison to conventional solid sand cores or shell cores. The reduced overall volume of the resin binder in the sand core 100 may result in reduction of gas evolution during casting.

If the mold cavity exhibits a rise relative to the horizon, reducing resin content below that summit may prove particularly advantageous. This is attributed to the natural migration of hot gases towards the high point in the mold cavity. Thus, areas that are physically at the high point of the mold cavity where hot gasses tend to migrate to during filling may have thicker walls, with the cavities 104 filled with the molding sand 106, to withstand high stress due to gas migration. In still more embodiments, the uncured molding sand 106 may include air gaps between individual sand grains, and these air gaps may exhibit an insulation effect on the sand core shell 102 during the casting process.

In additional embodiments, the sand core shell 102 may be a 3-dimensional (3D) printed sand core shell. For example, 3D printing may performed based on a 3D-mesh file. The 3D-mesh file may define one or more parameters for featuring the designed variability in the wall thickness of the sand core shell 102. For example, the one or more parameters may provide a precise blueprint for how the wall thickness shall vary across the sand core shell 102, allowing for custom variations at specific locations. Examples of custom variations can include varying the shape and size of the cavities 104 in different sections of the sand core shell 102 to achieve different wall thicknesses. Through these parameters, factors such as stress distribution, thermal management, and material efficiency can be controlled. The 3D-mesh file can incorporate various details such as gradients or patterns of thickness changes.

Conventional sand cores typically have randomized wall thickness and are never identical due to the nature of the sand blow and core box rotational manipulation. However, the sand cores 100 formed by a 3D-printing process are uniform and consistent as they are formed based on the 3D-mesh file which allows for precise control over the sand core structure. Thus, the variability in the wall thickness of the sand core shell 102 of the 3D-printed sand core 100 is not random or inconsistent but designed as per requirements.

In several embodiments, the sand core shell 102 may have one or more venting paths that open to an external space formed therein. These venting paths may function as gas migration channels from inside the sand core shell 102 to the external space. External space can be any space that is outside of the sand core 100. The outcome is a notable reduction or elimination of casting scrap, particularly due to gas blow defects. For example, as the gas that gets formed during casting migrates (or escapes) to outside of the sand core shell 102 via the venting paths, intricate internal passages formed within the casting by the sand core 100 effectively retain their desired shape. In numerous embodiments, the one or more venting paths may be integral to the sand core shell 102, and may be defined by the 3D-mesh file associated with the sand core shell 102. In other words, the one or more venting paths may be formed as part of the 3D-printing process, thus, eliminating the need of adding venting paths by a post processing drilling operation.

In several embodiments, an amount cured sand in a first section of the sand core shell 102 may be less than an amount of the cured sand in a second section of the sand core shell 102. For example, the amount cured sand in sections prone to gas migration may be lesser than sections that are less prone to gas migration. In other words, the sections of the sand core shell 102 that are prone to gas migration during casting may experience high stress and may need thicker walls to withstand the stress and heat. Thus, instead of providing entirely solid walls of cured sand in such areas, providing the cavities 104 filled with the molding sand 106 may be beneficial, emphasizing the strategic benefit of minimizing resin at such locations.

In many additional embodiments, the sand core 100 can be formed from different core materials having different material densities. In further additional embodiments, by adjusting 3D-printing parameters in the 3D-mesh file extent of hollowing can be controlled. For example, a volume of the cavities 104 in the sand core shell 102 can be varied by adjusting the 3D-printing parameters in the 3D-mesh file.

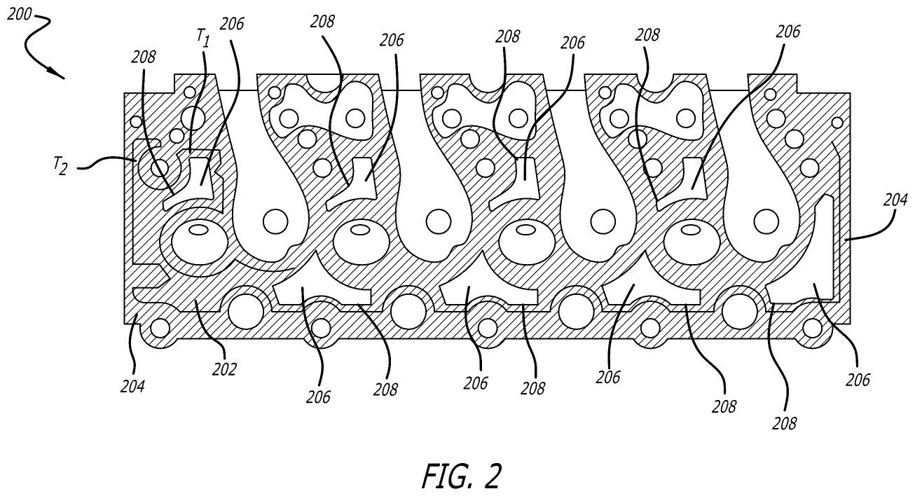

Although a specific embodiment for a hollowed-out sand core 100 is described above with respect to FIG. 1, any of a variety of systems and/or processes may be utilized in accordance with embodiments of the disclosure. In many further embodiments, the design and geometry of sand cores 100 can vary depending on changes in the casting requirement. For example, sand cores of different designs and geometries can be utilized to form internal passages or cavities within different casting part applications. The elements depicted in FIG. 1 may also be interchangeable with other elements of FIGS. 2-7 as required to realize a particularly desired embodiment.

Referring to FIG. 2, a conceptual illustration 200 of a sand core shell 202 of a sand core overlayed with a casting metal part 204 in accordance with various embodiments of the disclosure is shown. The sand core further includes molding sand 206 filled within cavities 208 formed in the sand core shell 202. As shown in FIG. 2, the sand core shell 202 features designed variability in wall thickness thereof. “Wall thickness” may refer to a measurement of distance between two opposite surfaces of a wall, typically taken from an outermost surface on one side to an outermost surface on the opposite side. For example, a first wall section of the sand core shell 202 may have a thickness “T₁”, while a second wall section of the sand core shell 202 has a thickness “T₂”, where “T₁” is greater than “T₂”. The first wall section is shown to include the cavity 208 filled with the molding sand 206, while the second wall section features a solid wall of thickness T₂ that is free of the molding sand 206. Thus, the thickness “T₂” may refer to full dimension of the second wall section measured perpendicularly from one outer face to the opposite outer face of the sand core shell 202. Further, the thickness “T₁” may refer to full dimension measured perpendicularly from an outermost surface on one side of the sand core shell 202 to an outermost surface on the opposite side of the sand core shell 202, encompassing both the solid material and the enclosed cavity 208.

In a number of embodiments, the molding sand 206 includes uncured, acid coated and non-catalyzed sand that is virtually inert and non-reactive for gas evolution. The casting metal part 204 may correspond to a solidified metal structure that has solidified around the sand core shell 202 during a casting process. Once the casting metal part 204 has solidified, the casting metal part 204 along with the sand core may be removed from the mold cavity, followed by a process to separate the sand core from the casting metal part 204.

Although a specific embodiment for a sand core shell 202 of a sand core overlayed with a casting metal part 204 is described above with respect to FIG. 2, any of a variety of systems and/or processes may be utilized in accordance with embodiments of the disclosure. In many further embodiments, the casting metal part 204 may be a cylinder head. The elements depicted in FIG. 2 may also be interchangeable with other elements of FIGS. 1, 3A-3G, and 4-7 as required to realize a particularly desired embodiment.

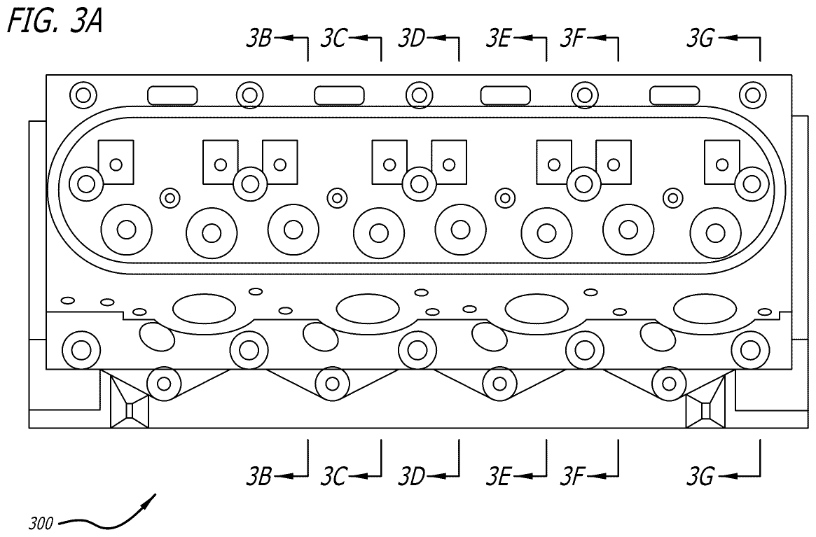

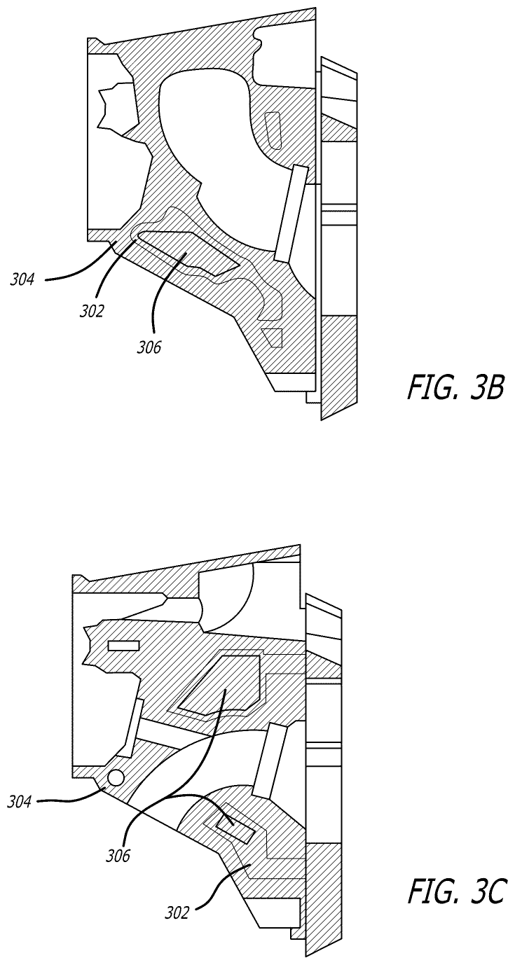

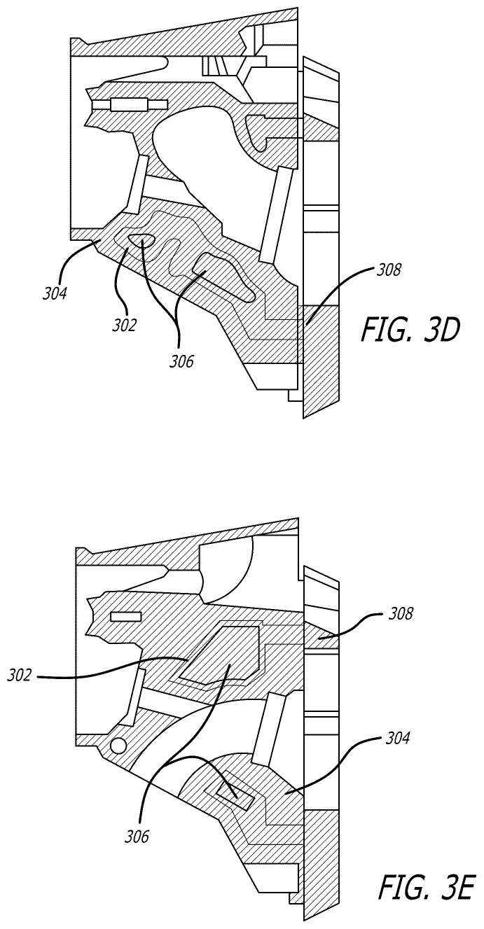

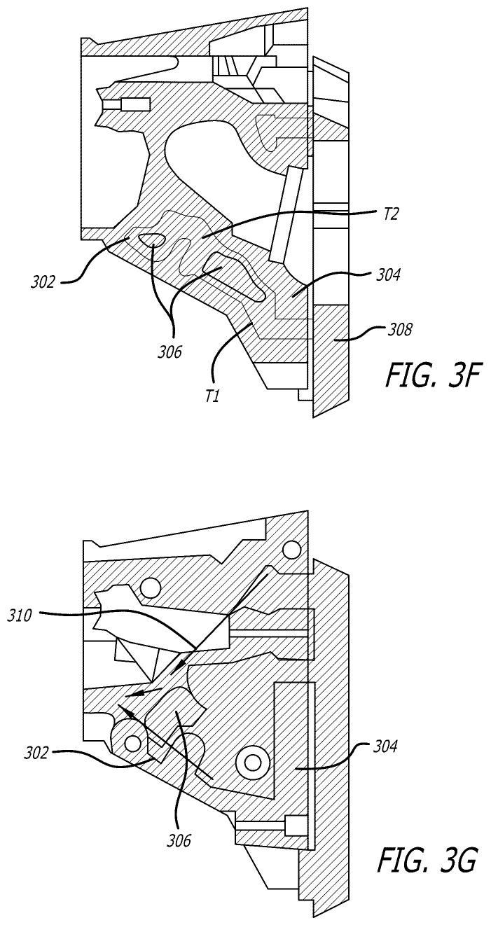

Referring to FIGS. 3A-3G, conceptual illustrations of various views of a casting metal part overlayed on a sand core in accordance with various embodiments of the disclosure are shown. While FIG. 3A illustrates a cross-sectional view of a hollowed casting metal part 300 overlayed on a sand core, FIGS. 3B-3G depict sectional views of the hollowed casting metal part 300 overlayed on the sand core along axes 3B-3B, 3C-3C, 3D-3D, 3E-3E, 3F-3F, and 3G-3G, respectively.

Referring now to FIGS. 3B and 3C, the hollowed casting metal part 300 of FIG. 3A when examined along axes 3B-3B and 3C-3C reveals a sand core shell 302 that is overlayed with a solidified metal 304. The solidified metal 304 is a sub-part of the hollowed casting metal part 300. The sand core shell 302 causes formation of internal passages within the casting metal part 300. Further, a network of uncured molding sand-filled, organic-shaped cavities 306 dispersed across the sand core shell 302 is revealed. The uncured molding sand filled in the cavities 306 includes uncured, acid coated and non-catalyzed sand that is virtually inert and non-reactive for gas evolution.

Referring now to FIGS. 3D, 3E, and 3F, the hollowed casting metal part 300 when examined along axes 3D-3D, 3E-3E, and 3F-3F reveals the sand core shell 302 that is overlayed with the solidified metal 304. Further, the network of uncured molding sand-filled, organic-shaped cavities 306 dispersed across the sand core shell 302 is revealed. Further, one or more core prints 308 of the sand core shell 302 are visible in FIGS. 3D, 3E, and 3F. The core prints 308 may be included on a first section of the sand core shell 302 to position the sand core shell 302 relative to a mold. Further, as shown in FIG. 3F, a first wall portion of the sand core shell 302 proximate to the core print 308 may be thicker than a second wall portion of the sand core shell 302 that is distant from the core print 308. For example, the first wall portion may have a thickness of T₁, while the second wall portion may have a thickness of T₂ where T₁ is greater than T₂. “Thickness” may refer to a measurement of distance between two opposite surfaces of a wall, typically taken from an outermost surface on one side to an outermost surface on the opposite side. Allowing the first wall portion to have greater thickness may prevent the core prints 308 to close off solid during the casting. Therefore, once the casting is complete, the first wall portion may provide a wider access point for breaking down and extracting the sand from the casting metal part 300.

Referring now to FIG. 3G, the hollowed casting metal part 300 when examined along axis 3G-3G reveals the sand core shell 302 that is overlayed with the solidified metal 304. Further, the sand core shell 302 includes the uncured molding sand-filled, organic-shaped cavities 306. Further, a trajectory of gas migration along one or more venting paths 310 of the sand core shell 302 is shown. This venting paths 310 corresponding to gas migration channels, shown by the section view along axis 3G-3G, may govern the flow of gases within the hollowed casting metal part 300. Providing dedicated gas migration path by leaving venting paths 310 in the sand core shell 302 optimizes the casting. This ensures that unwanted gases formed during casting are effectively expelled from inside of the sand core shell 302 to external space, achieving a high-quality end product.

It should be appreciated that efficient gas migration management is paramount in achieving uniform metal distribution during casting and minimizing the risk of defects, such as porosity and pockets, which could compromise the structural integrity of the hollowed casting metal part 300. Moreover, precise control over the venting paths 310 helps preventing the entrapment of residual gases within the hollow spaces of the sand core shell 302, as these can lead to imperfections in the hollowed casting metal part 300. Strategically configuring the venting paths (e.g., the gas migration routes) during formation of the sand core shell 302 helps optimize the casting conditions, reduce the likelihood of shrinkage-related defects, and enhance the mechanical properties and performance of the hollowed casting metal part 300.

In many embodiments, FIGS. 3B-3G provide insight into the 3D nature of the cavities 306, showcasing their dynamic relationship with the surrounding solidified metal 304. Further, FIGS. 3B-3G reveal that the cavities 306 can have any organic shape with varying sizes. Since the sand core shell 302 does not confirm to any specific geometric shape, the cavities 306 exhibiting freeform geometry integrate seamlessly with the geometry of the sand core shell 302. The freeform geometry allows for better adaptation to the irregularity of the sand core shell 302, thus helping reduce material of solid walls in the sand core shell 302. For example, in many embodiments the reduction may be quantified at substantially 50% less than traditional solid-core counterpart. It should be appreciated that in larger sections of the sand core shell, susceptible to gas evolution during casting, this reduction is accentuated, reaching up to 30%.

Although a specific embodiment for a casting metal part overlayed on a sand core is described above with respect to FIGS. 3A-3G, any of a variety of systems and/or processes may be utilized in accordance with embodiments of the disclosure. In many further embodiments, the first wall portion of the sand core shell 302 proximate to the core print 308 may also include the cavities 306. The elements depicted in FIGS. 3A-3G may also be interchangeable with other elements of FIGS. 1, 2, and 4-7 as required to realize a particularly desired embodiment.

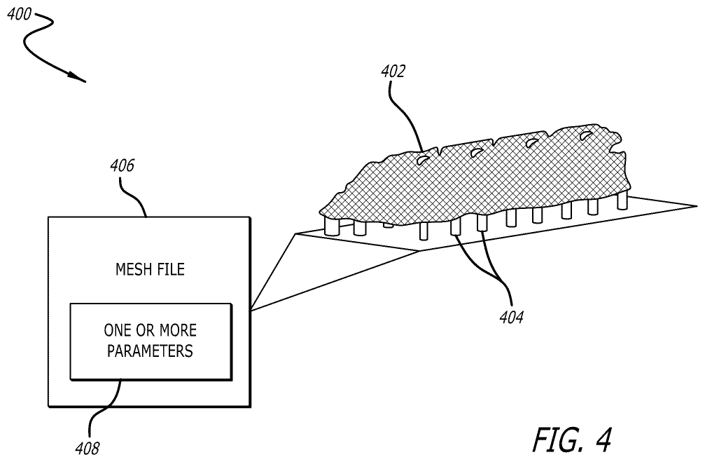

Referring to FIG. 4, a conceptual illustration of an example hollowed out, 3D printed sand core 402 in accordance with various embodiments of the disclosure is shown. In many embodiments, the sand core 402 may include core prints 404 to support and align the sand core 402 when placed relative to a mold cavity. In further embodiments, the sand core 402 may be a partially encapsulated sand core, resulting in a diminished contribution to blow-related issues encountered during the casting. In more embodiments, the sand core 402 may be 3D-printed based a 3D-mesh file 406. The 3D-mesh file 406 may define one or more parameters 408 of a structure of the sand core 402. For example, the one or more parameters 408 may define geometry, topology, and spatial organization of the sand core 402.

Although a specific embodiment for a hollowed out, 3D printed sand core is described above with respect to FIG. 4, any of a variety of systems and/or processes may be utilized in accordance with embodiments of the disclosure. In many further embodiments, the 3D-mesh file may further define type of material used to from different sections of the sand core 402. For example, for solid wall sections, the 3D-mesh file may define the use of a curing-compatible sand and binder mix, while for cavity sections, the 3D-mesh file may define the use of non-curable, acid coated and non-catalyzed sand. The elements depicted in FIG. 4 may also be interchangeable with other elements of FIGS. 1, 2, 3A-3G, and 5-7 as required to realize a particularly desired embodiment.

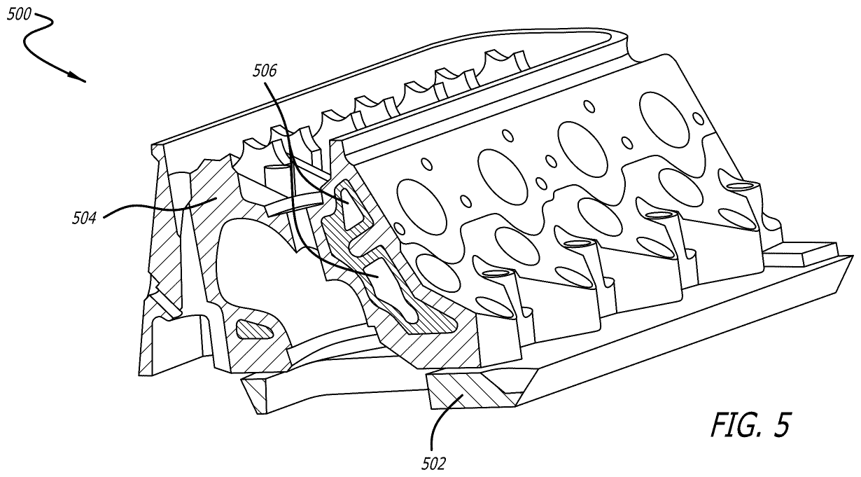

Referring to FIG. 5, a conceptual illustration of a cut section view 500 of a cylinder head removed from a molding cavity in accordance with various embodiments of the disclosure is shown. When removed from the molding cavity, the cylinder head may include a hollowed out sand core 502 surrounded by a solidified metal part 504 of the cylinder head. Further, the hollowed out sand core 502 may form internal passages in the cylinder head for a water jacket. The sand core 502 features designed variability wall thickness and uncured molding sand-filled, organic-shaped cavities 506.

Although a specific embodiment for a cylinder head removed from a molding cavity is described above with respect to FIG. 5, any of a variety of systems and/or processes may be utilized in accordance with embodiments of the disclosure. In many further embodiments, the casting part can be any hollowed out structure that requires formation of internal passages within it. The elements depicted in FIG. 5 may also be interchangeable with other elements of FIGS. 1-4, 6, and 7 as required to realize a particularly desired embodiment.

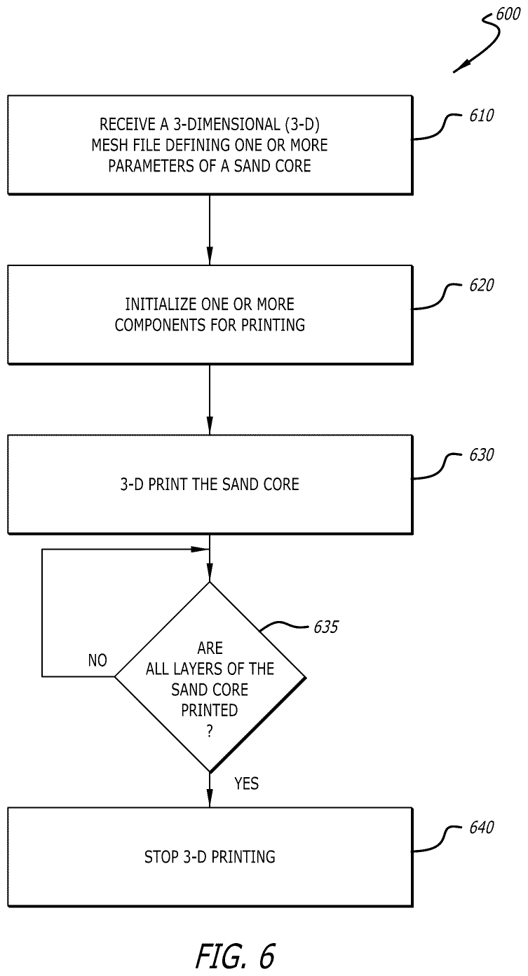

Referring now to FIG. 6, a flowchart showing a process 600 for forming a sand core in accordance with various embodiments of the disclosure is shown. In many embodiments, the process 600 may receive a 3D-mesh file defining one or more parameters of the sand core (block 610). For example, the process 600 may be implemented at a 3D-printing machine, which may receive the 3D-mesh file. The one or more parameters in the 3D-mesh file define the geometry, topology, and spatial organization of the sand core. For example, if the sand core is required to have variability in wall thickness, the one or more parameters in the 3D-mesh file may define precise thickness of different wall sections of the sand core. In further examples, if the sand core is required to have solid walls in certain sections and uncured molding sand-filled, organic-shaped cavities in other sections, the one or more parameters in the 3D-mesh file may define precise locations, coordinates, and materials to be used to form solid walls and the molding sand-filled cavities.

In more embodiments, the process 600 may initialize one or more components for printing (block 620). For example, during initialization, the process 600 may adjust a print bed for leveling and position one or more printer heads at the correct start positions defined in the 3D-mesh file.

In still more embodiments, the process 600 may print the sand core (block 630). In numerous embodiments, 3D-printing the sand core may include layer-by-layer deposition of requisite material as per the 3D-mesh file. In yet more embodiments, during the layer-by-layer deposition, the printer heads may selectively deposit materials to differentiate between the solid walls of the sand core and the hollow cavities within the sand core. For example, the solid wall sections may be printed using a curing-compatible sand and binder mix, while the cavities may be filled with a different material, such as non-curable, acid-coated and non-catalyzed sand. In further embodiments, during the layer-by-layer deposition, one or more venting paths that allow gas migration during casting may be formed within the sand core. The one or more venting paths may be defined in the 3D-mesh file.

In further embodiments, the process 600 may determine whether all layers of the sand core are printed (block 635). For example, the 3D-mesh file may define a number layers to be printed to form the sand core. To determine whether all layers of the sand core are printed, the process 600 may compare the number of layers defined in the 3D-mesh file with a current layer number. If the current layer number matches the number of layers defined in the 3D-mesh file, the process 600 may determine that all the layers of the sand core are printed. However, if the current layer number is less than the number of layers defined in the 3D-mesh file, the process 600 may determine that all the layers of the sand core are yet to be printed.

In many further embodiments, if the process 600 determines that all layers of the sand core are not printed yet, the process 600 may continue checking till all the layers are printed (block 635). However, if the process 600 determines that all layers of the sand core are printed, the process 600 may stop 3D-printing (block 640). After 3D-printing is stopped, the final sand core structure may be exposed to high temperatures for curing. Since the organic-shaped cavities are filled with the non-curable, acid coated and non-catalyzed sand, only the solid walls of the sand core gets cured and molding sand within the cavities remain uncured.

Although a specific embodiment for forming a sand core is described above with respect to FIG. 6, any of a variety of systems and/or processes may be utilized in accordance with embodiments of the disclosure. In many further embodiments, despite the focus on internal optimization, structural integrity remains paramount. For example, the 3D-printed sand core may be configured to withstand the mechanical stresses and thermal cycles during casting. In additional embodiments, the choice of material for 3D-printing the sand cores may be an important variable. The sand core should ideally possess the necessary thermal conductivity, strength, and durability to withstand the harsh conditions during casting. Factors such as printing speed, layer adhesion, and post-processing requirements can be optimized to ensure cost-effective and scalable production. The elements depicted in FIG. 6 may also be interchangeable with other elements of FIGS. 1-5 and 7 as required to realize a particularly desired embodiment.

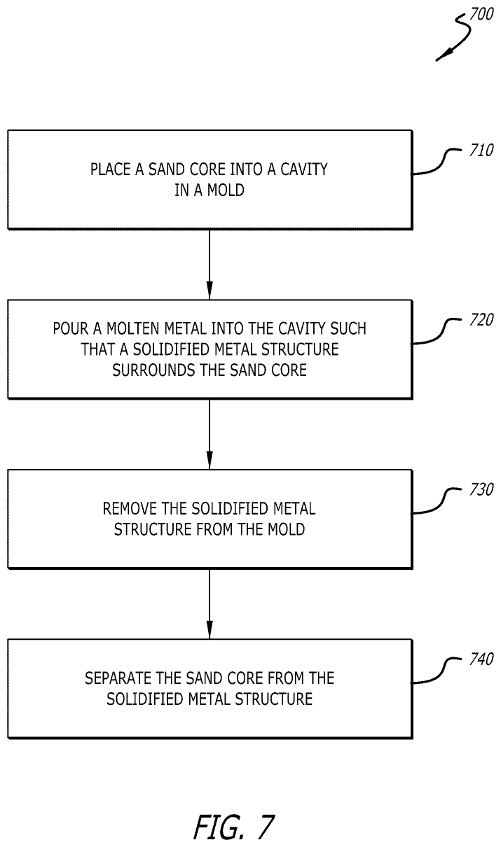

Referring now to FIG. 7, a flowchart showing a process 700 for a casting method in accordance with various embodiments of the disclosure is shown. In many embodiments, the process 700 may place a sand core into a cavity in a mold (block 710). The sand core may include a sand core shell that features a designed variability in wall thickness thereof, and has one or more venting paths that open to an external space formed therein. Further, the sand core may include molding sand filled in the sand core shell. The molding sand may include non-curable, acid coated and non-catalyzed sand. In more embodiments, the molding sand may be filled in one or more organic-shaped cavities formed within the sand core shell. For example, the sand core shell may include a first section, such as a solid wall formed of cured sand, that is free of uncured sand, and a second section that has the uncured sand filled in the organic-shaped cavities. The organic-shaped cavities seamlessly integrate with irregular geometry of the sand core.

In further embodiments, the process 700 may pour a molten metal into the cavity (block 720). The molten metal may solidify around the sand core to form a solidified metal structure. In many further embodiments, the process 700 may remove the solidified metal structure from the mold (block 730). Since the solidified metal structure surrounds the sand core, the sand core also gets removed from the cavity when the solidified metal structure is removed.

In additional embodiments, the process 700 may separate the sand core from the solidified metal structure (block 740). In an example, the sand core may be separated from the solidified metal structure by a shakeout process. During the shakeout process, the outer crust of the sand core breaks which exposes the uncured, free-flowing molding sand within the cavities. The molding sand thus escapes the cavities in the shakeout process along with the solid cured sand.

Although a specific embodiment for a casting method is described above with respect to FIG. 7, any of a variety of systems and/or processes may be utilized in accordance with embodiments of the disclosure. In many further embodiments, after the sand core is separated from the solidified metal structure, the solid metal structure may be cleaned to remove any traces of trapped sand. The elements depicted in FIG. 7 may also be interchangeable with other elements of FIGS. 1-6 as required to realize a particularly desired embodiment.

Although the present disclosure has been described in certain specific aspects, many additional modifications and variations would be apparent to those skilled in the art. Any of the various processes described above can be performed in alternative sequences and/or in parallel to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A sand core for casting, comprising:
a sand core shell that features a designed variability in wall thickness thereof, and has one or more venting paths that open to an external space formed therein; and
molding sand partially filled in the sand core shell, wherein the molding sand comprises coated, non-catalyzed sand.

2. The sand core of claim 1, wherein the sand core shell is a 3-Dimensional (3D)-printed sand core shell.

3. The sand core of claim 2, wherein the designed variability in the wall thickness is based on a 3D-mesh file associated with the sand core shell.

4. The sand core of claim 3, wherein the sand core shell includes one or more core prints on a first section of the sand core shell to position the sand core shell relative to a mold.

5. The sand core of claim 4, wherein a first wall portion of the sand core shell proximate to the one or more core prints is thicker than a second wall portion of the sand core shell that is distant from the one or more core prints.

6. The sand core of claim 2, wherein the one or more venting paths are integral to the sand core shell.

7. The sand core of claim 6, wherein the one or more venting paths are defined by a 3D-mesh file associated with the sand core shell.

8. The sand core of claim 1, wherein the molding sand comprises uncured sand.

9. The sand core of claim 8, wherein the sand core shell comprises at least one first section free of uncured sand and at least one second section featuring at least one cavity filled with the uncured sand.

10. The sand core of claim 9, wherein the at least one cavity exhibits freeform geometry.

11. The sand core of claim 9, wherein a material of the at least one first section is different from the uncured sand.

12. The sand core of claim 8, wherein the uncured sand includes air gaps between individual sand grains, and the air gaps exhibit an insulation effect on the sand core shell.

13. The sand core of claim 8, wherein the uncured sand is acid coated sand.

14. The sand core of claim 1, wherein the one or more venting paths that open to the external space function as gas migration channels from inside the sand core shell to the external space.

15. The sand core of claim 1, wherein the sand core is a water jacket sand core.

16. A method for forming a sand core, comprising:
3-Dimensionally (3D) printing a sand core shell that features a designed variability in wall thickness thereof, wherein the sand core shell comprises:
one or more venting paths that open to an external space; and
one or more cavities filled with molding sand, wherein the molding sand comprises coated, non-catalyzed sand.

17. The method of claim 16, wherein the sand core shell is 3D-printed based on a 3D-mesh file.

18. The method of claim 17, wherein the 3D-mesh file is configured to indicate one or more parameters for featuring the designed variability in the wall thickness of the sand core shell.

19. A casting method, comprising:
placing a sand core into a cavity in a mold, wherein the sand core comprises:
a sand core shell that features a designed variability in wall thickness thereof, and has one or more venting paths that open to an external space formed therein, and
molding sand filled in the sand core shell, wherein the molding sand comprises coated, non-catalyzed sand;
pouring a molten metal into the cavity, wherein the molten metal solidifies around the sand core to form a solidified metal structure;
removing the solidified metal structure from the mold; and
separating the sand core from the solidified metal structure.

20. The casting method of claim 19, wherein the sand core is a water jacket sand core and the solidified metal structure is a cylinder head.
